(19) United States
(12) Patent Application Publication
(10) Pub. No.: US 2015/0349432 A1
(43) Pub. Date: Dec. 3, 2015

(54) WAVELENGTH COMPRESSED ANTENNAS

(71) Applicant: Physical Devices, LLC, Durham, NC (US)

(72) Inventor: Frederick Vosburgh, Durham, NC (US)

(21) Appl. No.: 14/727,255

(22) Filed: Jun. 1, 2015

Related U.S. Application Data
(60) Provisional application No. 62/006,561, filed on Jun. 2, 2014.

(51) Int. Cl. H01Q 19/09; H04B 1/16; H04B 1/10; H01Q 1/36

(52) U.S. Cl. CPC H01Q 19/09; H01Q 1/36; H04B 1/16; H04B 1/1027

(57) ABSTRACT

Devices and methods for wavelength compression antennas and for arrays composed thereof are disclosed. Composed of individual wavelength compressing antennas, such arrays are of reduced size but avoid the mounting constraints and cost of containerized arrays. They also provide wider bandwidth for jammer cancellation, direction finding, beam steering and other array applications.

### PRIORITY CLAIM

This application claims the benefit of U.S. Provisional Patent Application Ser. No. 62/006,561, filed Jun. 2, 2014; the disclosure of which is incorporated herein by reference in its entirety.

### TECHNICAL FIELD

The subject matter described herein relates to antennas. More specifically, the subject matter described herein relates to expanded bandwidth in reduced size antennas. One application is direction finding arrays of reduced size and/or expanded bandwidth.

### BACKGROUND

Radios use directional antennas, e.g. phased arrays, to enhance range and reduce interference. Often, however, the use of arrays is limited by practical constraints such as cost and size. Size constraints are important at all frequencies, antenna arrays for the widely used high frequency (HF) band typically have a half-lambda separation of elements of up to 50 meters. Clearly, such large separations make arrays ill-suited to mobile platforms, e.g., a surveillance drone. As a result, directional reception, e.g., for direction finding, at such frequencies often is achieved by digital signal processing, e.g., simulating a long baseline with signals received while a platform is in transit, but this requires costly and power hungry technology as well as signals that remain unchanged long enough to establish a vertical long baseline by moving one antenna precisely along a transit track.

A related situation exists in the consumer wireless industry despite the differences in wavelength. While multiple-input/multiple-output (array) technology is being introduced cell towers and Wi-Fi hotspots to support more simultaneous users, makers of cell phones and Wi-Fi tablets continue to rely on crude antennas mounted wherever there is space within the phone. Previously disclosed array technology (U.S. Pat. No. 6,246,369, hereinafter, “the '369 Patent”) employs a high dielectric container surrounding a planar array of contiguous antennas to achieve size reduction. Unfortunately, this approach, in addition to being costly, requires a large area within the phone or tablet, resulting in a larger, most costly phone. Clearly, the industry would benefit from low cost antenna arrays that also meet the size and placement constraints of consumer wireless handset products.

In light of the above, we disclose devices and methods of arrays comprising proximate sets of separately mountable wavelength compressive antennas.

### SUMMARY

One aspect of the invention is to provide a wavelength compression antenna (WCA) or equivalently wave compression element. A second aspect is a WCA type array antenna. A third aspect is a small array of antennas. A fourth aspect is a method of cancelling interference. A fifth aspect is a method of direction finding. A sixth aspect is directional transmitting of a signal. A seventh aspect is wavelength dilating a signal.

The subject matter described herein can be implemented in software in combination with hardware and/or firmware. For example, the subject matter described herein can be implemented in hardware. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Embodiments of the subject matter described herein will now be explained with reference to the accompanying drawings, wherein like reference numerals represent like parts, of which:

FIG. 1 is a block diagram illustrating an exemplary wavelength compressive array antenna according to an embodiment of the subject matter described herein;

FIG. 2 is a graph illustrating a wavelength compression effect utilized by an exemplary wavelength compressive array antenna according to an embodiment of the subject matter described herein;

FIG. 3 is a flow chart illustrating an exemplary process for utilizing a wavelength compression effect according to an embodiment of the subject matter described herein; and

FIGS. 4a and 4b are graphs illustrating wavelength compression effects of fresh water and sea water (FIG. 4a) and wavelength compression versus conductivity (FIG. 4b).

### DETAILED DESCRIPTION

In accordance with the subject matter disclosed herein, wavelength compressed antennas and systems for using same are provided.

Reference will now be made in detail to exemplary embodiments of the subject matter described herein, examples of which are illustrated in the accompanying drawings. Wherever possible, the same reference numbers will be used throughout the drawings to refer to the same or like parts. The present disclosure is in terms of wavelength compressive antennas and arrays composed thereof (collectively “WCA”), such as provided by deceleration of phase velocity without substantially altering frequency of a signal. It is intended to cover all uses of miniaturized antennas or array antennas to transmit or receive RF signals.

The present disclosure is primarily in terms of arrays for high frequency (HF) direction finding and of cell phone antennas but is intended to encompass antenna devices and methods for wireless data transfer at any frequency between 1 Hz and 100 GHz. WCA disclosed herein may comprise one or more antenna of reduced size, e.g. having a dimension that be a fraction or multiple of the compressed signal's wavelength, e.g., including, but not limited to, one, one half, one fourth, or less than 0.2 of a signal's compressed free space wavelength (λ₀) lambda, among other sizes. The amount of antenna dimension reduction may depend on the amount of wavelength compression by the wavelength compressing layer. For example, if the antenna element is a half-wave dipole, the antenna length is set to λ/2, where λ is the wavelength of the signal incident on the antenna. Assuming that the wavelength compressive layer compresses the original signal's wavelength to 20% of the original signal's wavelength, the half dipole antenna length could be set to 0.2*(λ_{original}/2), where λ_{original} is the wavelength of the original (uncompressed) signal. Such antennas are described hereafter as miniaturized and/or electrically small. The present disclosure is intended to cover expansion of bandwidth of any type of miniaturized, electrically small or other antenna. While described in terms of classical magneto-dielectric loading, antennas can be miniaturized by other means as well, for example using metamaterial and/or metasurface (collectively “metamaterial”) technology to reduce the resonant frequency of the antenna underlying the nanofilm coating described herein. Although described in terms of single antennas and two-element arrays, the present disclosure is intended to cover arrays comprising any plurality of elements, e.g. MIMO antennas for cell phones or radar imaging arrays, among others.

For the purposes of the present disclosure an array is defined as any set of antennas providing signals that may be combined or otherwise processed together for directional RF sending or receiving purposes. As such, arrays may comprise any spatial arrangement. WCA may comprise any separation or plurality of separations, such as a separation equivalent to a fraction or multiple of compressed wavelength. One illustrative spacing is one-half lambda. Another illustrative separation is log periodic. Although described primarily in terms of wavelength compression, this disclosure is intended also to cover admixtures of wave compression and other types of antenna. In the present disclosure, the conductor is defined as the portion of an antenna that can interconvert wireless and electrical signals; the conductor can also be referred to as a resonator.

While described in terms of high dielectric materials, the present disclosure is intended to cover devices and methods employing low and/or negative dielectric materials, i.e. any providing wavelength dilation. High dielectric material is defined herein as any having a dielectric constant with a magnitude greater than 3. And, permittivity is used interchangeably with dielectric constant.

WCA devices may be used in any array antenna method. One example is steering transmit (“uplink”) signals to a cell tower or Wi-Fi hotspot. Uplink steering may be used to increase transmit range and/or decrease power drain. WCA may be used to provide antenna gain in the direction of a desirably received signal as means of improving detection range and/or direction finding (“DF”). WCA may be used to desensitize reception in the direction of a desirably mitigated signal and/or to cancel interference (“anti-jamming;” AJ), including self-interference, by any method. Illustrative means of cancelling jamming is disclosed in U.S. Pat. No. 8,666,347 (hereinafter, “the '347 Patent”) which is assigned to the assignee of the present invention and the disclosure of which is incorporated herein in its entirety by reference. Illustrative means of cancelling self-interference is disclosed in U.S. provisional patent application Ser. No. 61/968,128 (the '128 Application) which is assigned to the assignee of the present invention and the disclosure of which is incorporated herein in its entirety by reference.

WCA may be used to provide DF, for example in the HF band for which antennas would otherwise require separations of tens of meters. By compressing wavelength, array type WCA may be constructed with an element spacing that may be reduced in proportion to magnitude of compression without degrading array performance. For example, compressing a 100 m (3 MHz) signal by a factor of 10 may be used to construct an array with lambda/2 spacing reduced from 50 to 5 m. While such a reduced separation is quite valuable, e.g. for use on reconnaissance drones, containerized covering of such widely spaced antennas with a high dielectric material, as described in the '369 Patent, would be subject to wavelength decompression as the signal exited the described dielectric box set apart from the array it surrounds, thereby negating the compression effect due to first encounter of the box by the signal. As described in the '369 Patent, the embodiment also is impracticable in space constrained implements, e.g. inside a cell phone, where antenna placement and space requirements may be dictated by the size of the phone and arrangement of non-antenna components. The array described in the '369 Patent is also wasteful and costly in proposing a large box of expensive material around the entire array.

Smartphones today employ diversity antennas which are set apart from the primary antenna on a space available basis. Mounting such widely separated antennas with a high dielectric container would adversely affect subjacent electronics as well as requiring redesign and increase in size of the phone. Clearly, primary and diversity antennas that are individually of wavelength compression type, which can be mounted within the form factor of an existing phone case while providing steered operation would clearly be desirable.

Wavelength compression may be used to increase the precision of direction finding or magnitude of anti-jamming by increasing the amplitude difference between two element signals thereby enabling more accurate calculation of phase shift according to the '347 Patent. Reducing element separation may be used to reduce relative delay between signals from a plurality of antennas or array elements, as means of reducing dispersion over frequency of a signal and, thereby, increasing effective bandwidth of directional receiving methods. Relative delay is defined here as difference in group delay between signals from a plurality of antennas or array elements. Increasing amplitude difference may be conducted for higher frequency signals by substituting wavelength dilation for wavelength compression. Frequencies for which dilation is desirable depends in part on specification of available circuits, e.g. their amplitude resolution and phase jitter. One example based on low cost commercial component may utilize wavelength dilation at for frequencies above 5 GHz, although this is only illustrative not a fixed criteria.

It is universally accepted that miniaturizing an antenna, i.e., reducing its resonant frequency to match the frequency of a signal propagating in space, also narrows or constricts range of frequencies that are can be received efficiently with such an antenna. This phenomenon, which is commonly referred to as the Chu Effect, is set forth in various models reflecting antenna bandwidth (BW) to such parameters as the wavelength (λ₀) of an antenna and the thickness (t) and material properties, i.e. magnetic permeability (μ) and dielectric permittivity (∈) of a miniaturizing slab beneath the resonator, summarized in Eq. 1;

BW∝t/λ₀*(sqrt(∈)) (1)

with the various equations reported in the literature having various constants to fit the general equation to specific data sets, and which illustrate the dramatic constriction of bandwidth by high ∈ slabs set under the resonator to reduce its center frequency and, thereby, match it to in-bound signals.

Eq. 1 also illustrates the increase in bandwidth made possible by compressing wavelength of a signal before it strikes the underlying resonator. The nanofilm coating disclosed here operates by refraction rather than the magneto-dielectric loading in common use. As a result, a nanofilm coating can be made extremely thin, e.g. less than 1 micron, to minimize attenuation while providing full compression of the wavelength and, thereby, pre-expansion of antenna bandwidth. The pre-expansion in bandwidth for a given antenna is inversely related to the amount of wavelength compression by the coating layer as indicated by equation 1. Thus, if the coating layer reduces the wavelength of incident signals by a factor of 10, the bandwidth of the antenna array can be said to be pre-expanded by a factor of 10

The relative refractive index of a material is proportional to the square root of its permittivity (∈) as a result, the pre-expansion in bandwidth (δBW) can be written (Eq. 1) as:

δBW∝Sqrt(∈) (2)

Because the mass of nanofilm is extremely small relative to a magneto-dielectric slab, its contribution to bulk loading via sqrt(μ∈) and, therefore, to center frequency of the resonator is insignificant. The result is any type of miniaturized antenna can be provided an expanded bandwidth over antennas of the same size that do not include a wavelength compressive coating layer.

Because the nanofilm operates by refraction, vs. magneto-dielectric loading, it can be extremely thin yet provide full compression, thereby minimizing any thickness-dependent attenuation of signals striking the antenna. As such the technology disclosed herein can be used to increase data rate and/or antenna pass-band width of an miniaturized antenna as means of providing enhanced wireless or other radio communications while also reducing size and/or cost of the antenna(s).

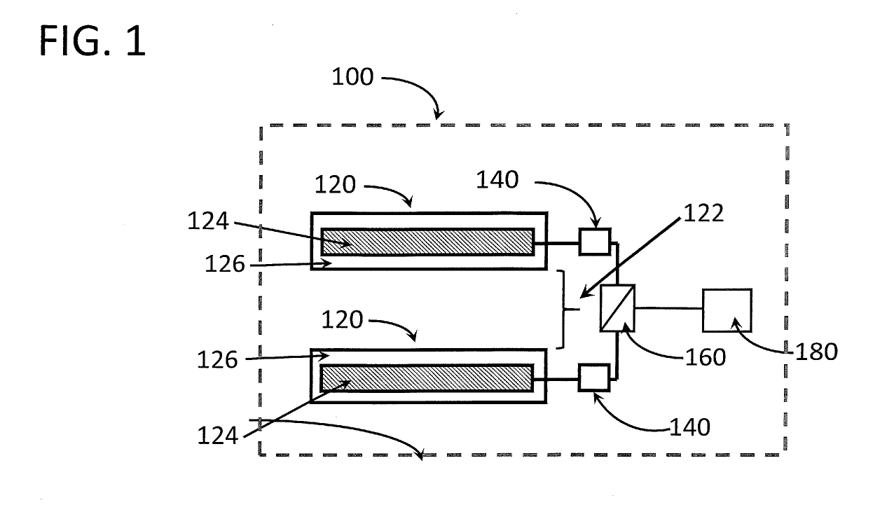

FIG. 1 is a block diagram illustrating an exemplary wavelength compressive array antenna according to an embodiment of the subject matter described herein. In the embodiment illustrated in FIG. 1, an antenna array 100 includes a plurality of antenna elements 120 set apart with a spacing based on compressed wavelength, although other spacings are also acceptable. Element 120 may be any type that can modify RF signal wavelength, such as by wavelength compression or dilation. Element 120 is electrically connected to antenna electronics 140. In one embodiment, antenna electronics 140 may include an amplifier, a phase shifter, and a terminal connected in series, with the terminal being on the outside for connecting antenna element 140 to a combiner 160. Combiner 160 which may be of any type that can combine electronics output signals. Combiner 160 may further comprise a down converter of any type that can convert combined signals to lower frequency range. The down converter may further comprise a low pass or image-rejection filter. Combiner 160 is connected to a processor 180. Processor 180 is of any type that can process combined or down converted signals. An illustrative processor 180 is a radio. Processor 180 may be any type that can control antenna electronics 140.

Element 120 may be of a type, e.g. dipole or patch, or size, e.g. quantified by length, spacing or diameter. Size may be proportional to compressed wavelength, although this is not required. One example is a patch element 120 having a diameter equal to 1 compressed wavelength. Separation 122 may be proportional to compressed wavelength, e.g. lambda/2, although other separations are also acceptable.

Element 120 may comprise an electrical conducting portion (“conductor”) 124 and compressing layer (CL) 126. CL 126 may comprise a wave compressive material, such as a high dielectric or lossy dielectric material. CL 126 may comprise a coating type applied to conductor 124. In some embodiments, the compressive material may be any type that can be applied by sputter coating, spin coating among other thin coat application means. In some embodiments, CL 126 may comprise a compressive device, such as slow wave transmission line, connected between conductor 124 and electronics 140. Slow wave transmission line may be used instead of or together with conductor covering type of CL 126 in various arrays.

CL 126 may be applied to substantially all of conductor 124 or a portion thereof, e.g., to an outward directed face. CL 126 may comprise any construction, for example one or more layers of one or more material. CL 126 may have a dielectric constant that is at least one of; high, negative and controllable.

CL 126 may be in contact (e.g., in direct physical contact) with at least a portion of conductor 124. It is important that CL 126 be in contact with the resonator or else the wavelength will re-expand the instant it passes out of the layer, e.g. back into air between the layer and resonator.

The wave compressive material used in CL 126 may comprise any type that can compress the wavelength of an RF signal at the interface between that material and a medium, e.g. air or space, without substantially altering signal frequency. The material may comprise a relatively high value for at least one of: dielectric constant, permittivity and index of refraction (hereinafter “permittivity”). The material may comprise fixed or variable permittivity. The permittivity may comprise at least one aspect of real and imaginary. The permittivity may be tunable, e.g., as in a varactor. Tunable permittivity may be used in adjustment of wavelength compression to enhance antenna impedance matching.

Examples of high permittivity type compressive material that may be used in CL 126 include titanates, e.g., a strontium and/or barium containing, semiconductors, water or glass, among other materials. The material used in CL 126 may further comprise one or more added constituents, e.g., through doping or ionic inclusion. Examples include doping of a titanate. Ionic inclusion may comprise adding a salt or other charged moiety. While in most cases, the real aspect of permittivity dominates the dielectric constant effect, salt water has a very high dielectric constant, reflecting the contribution of its imaginary aspect. CL 126 may comprise a low loss material property. CL 126 may comprise a low loss construction, e.g., comprising a thin layer. An example of a low loss type wavelength compression interface that may be used in CL 126 is a thin layer of strontium titanate, such as might be applied by sputter coating or by spin coating among other methods. A thin layer is defined herein as any thickness between 0.01 angstrom and 10 millimeters, although other thicknesses are also acceptable. The permittivity may be changeable, e.g., by tuning the real or imaginary permittivity of CL 126 as means of matching compressed wavelength to conductor dimension over a range of frequencies to improve reception at a range of frequencies.

Antenna electronics 140 may be of any type that can modify wavelength compressed signals provided by antenna 120 or slow wave transmission line. As stated above, electronics 140 may comprise a phase shifter, and an amplifier of any type. One illustrative configuration for antenna electronics 140 is that described in the '347 Patent. Another illustrative embodiment comprises a variable amplifier followed by phase shifter. Yet another embodiment may comprise phase shifter followed by amplifier. Electronics 140 may comprise any type of signal-passing filter that can reject undesirable frequencies, connected before or after phase shifter.

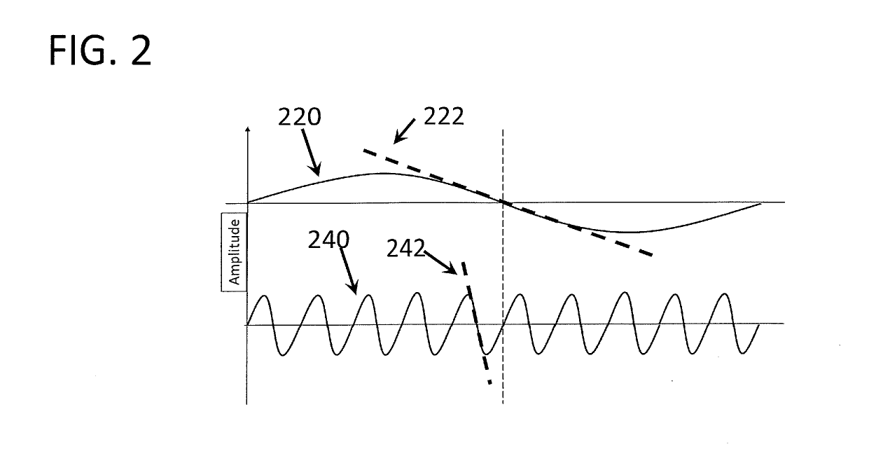

FIG. 2 is a graph illustrating a wavelength compression effect utilized by an exemplary wavelength compressive array antenna according to an embodiment of the subject matter described herein. FIG. 2 illustrates the effect of wavelength compression of a signal encountering a CL 126, depicting the RF signal before 220 and after 240 such compression. Compression has the effect of increasing pre-compression slope 222 to a steeper post-compression slope 242. The difference in slope 222, 242 at a given point in the signal cycle is proportional to the magnitude of compression provided by CL 126. By way of illustration, Strontium titanate (dielectric constant ˜300) can compress wavelength ˜17-fold, yielding a proportional increase of amplitude slope 222, 242 and enabling a proportional reduction in element spacing.

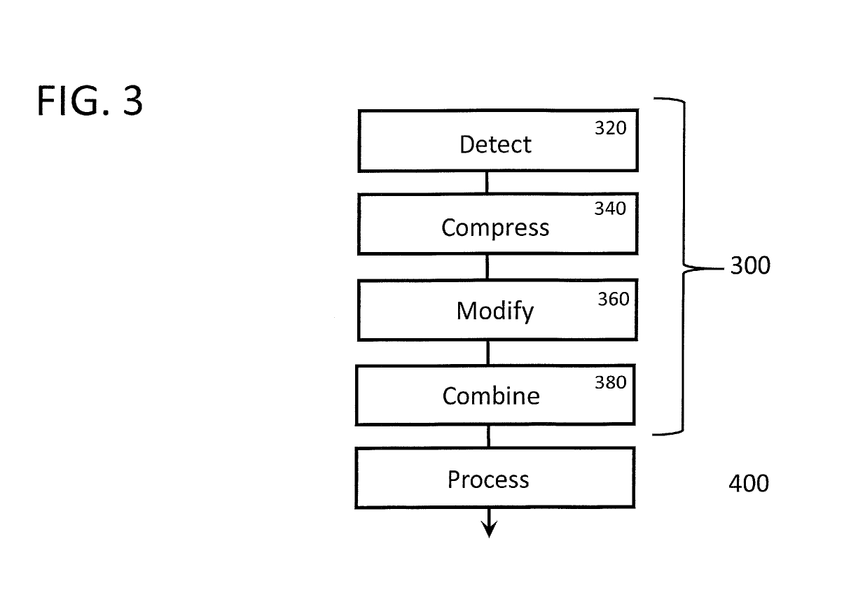

FIG. 3 is a flow chart illustrating an exemplary process for utilizing a wavelength compression effect according to an embodiment of the subject matter described herein. In the embodiment illustrated in FIG. 3, method 300 includes the steps of detecting 320 an RF signal, compressing 340 the detected signal, modifying 360 the compressed signal and combining 380 the modified signals. Combined signals may be processed 400 by any suitable means.

Detecting 320 may be conducted for a plurality of antenna element. Compressing 340 detected signals may comprise slowing signal phase velocity. Slowing may be conducted using a high dielectric material to provide an interface between conductor and the surrounding medium. Slowing may be conducted using a slow wave type transmission line connecting antenna to antenna electronics.

Modifying 360 may comprise phase shifting and, in some cases, amplifying and/or filtering. The amplifying aspect of modifying 360 may comprise equalizing the amplitude between signals from different antenna elements to be combined as described in the '347 Patent. Phase shifting may comprise phase aligning at a desired frequency signals to be combined and/or processed. Phase aligning may comprise providing in phase, out of phase or anti-phase alignment of at least one portion of detected signal.

Combining 380 may be conducted by any means such as with a balun or other circuit type. Combining may further comprise down converting combined signal, for example to intermediate or baseband frequencies. Down converted signals may be filtering using a low pass, bandstop or image rejection type filter.

Processing 400 may comprise any methods applied to RF signals, such as down converting, harmonic rejecting, filtering or direct converting among others. Processing 400 may comprise determining or controlling phase shifting, e.g. according to the '347 Patent.

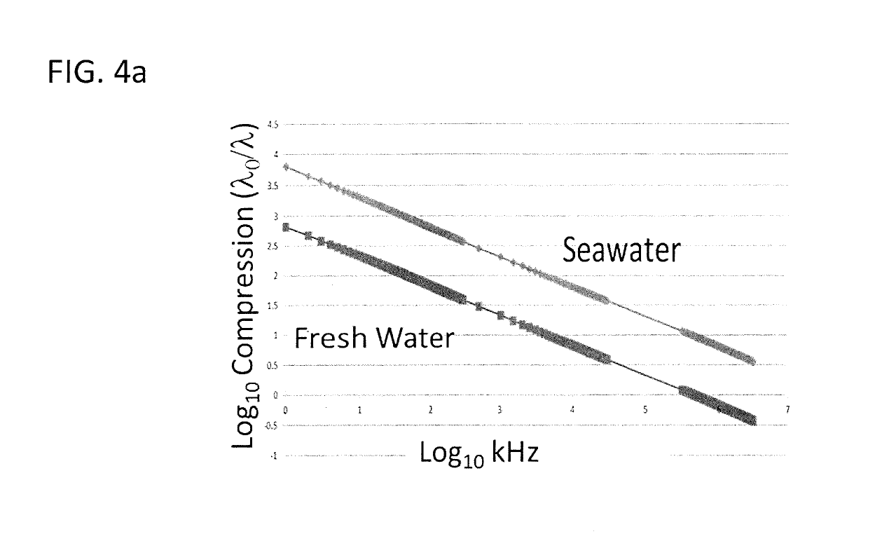

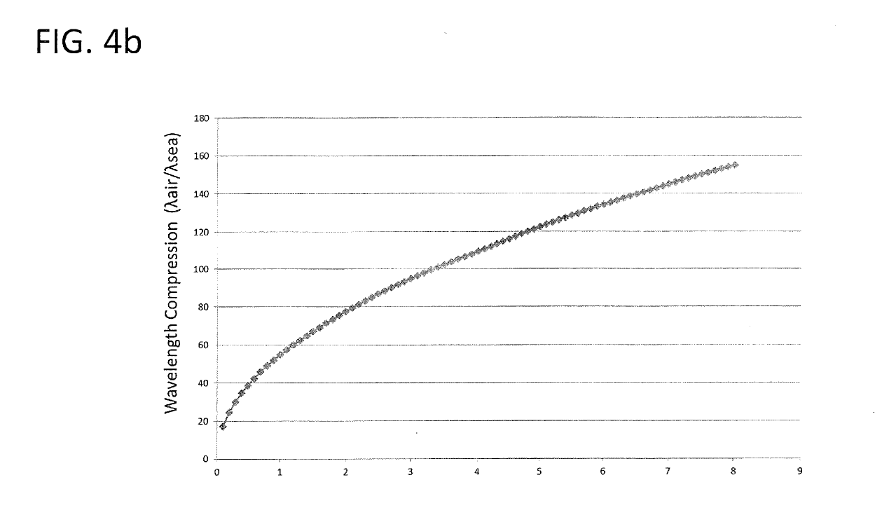

FIG. 4a shows the wavelength compression (λ₀/λ) effect of fresh water (0.05 Siemens/m) and seawater (4.5 Siemens/m), illustrating the log-log relationship between compression and frequency, with seawater providing ˜100× additional compression at any frequency.

FIG. 4b illustrates HF wavelength compression at 3 MHz as a function of conductivity from fresh water to seawater. At 3 MHz, the model predicts wavelength compression of ˜18× for a dielectric material equivalent to fresh water and ˜50× for a material equivalent to brackish river water (˜1.2 S/m), the latter reducing the 100 m wavelength to 2 m. As an alternative to a lossy dielectric like brackish water, the same compression can be achieved with a material having a very high real dielectric constant or a dielectric material having a complex, real plus lossy, effect of the desired magnitude.

One example of a high (real) dielectric material that may be used for CL 126 is barium titanate. With a dielectric constant of 1250, it is predicted to compress wavelength ˜35×. Altering the material e.g. by doping or adding a charged constituent, may be expected to provide greater compression, e.g. the 50× above. Such a level of compression, at 3 MHz, enables half-wavelength spacing of 1 m, resulting in dramatic reduction in the size and weight of an HF array thereby enabling its mobile use, e.g. with man-portable radios or unmanned air vehicles.

While described in terms of wave compressive antenna elements, the present disclosure is intended to cover use of slow wave transmission lines as means of compressing signals from any type of antenna or arrays thereof. For example, elements of an existing array may be connected to antenna electronics via a slow wave type transmission lines as means of providing wavelength compression.

It will be appreciated that at higher frequencies, wavelengths are shorter, making resolution of phase and control of phase shift more difficult which requires more advanced and costly circuitry to provide desirable levels of phase shifting. In such cases, a wavelength compressive antenna, or array, of such antennas, having an interface composed of negative permittivity material will dilate the wavelength of high frequency signals, enabling desirable levels of resolution and control without costly circuitry. As such dilating type array will enable array operations at higher frequency at lower cost.

It will be understood that various details of the subject matter described herein may be changed without departing from the scope of the subject matter described herein. Furthermore, the foregoing description is for the purpose of illustration only, and not for the purpose of limitation.

What is claimed is:

1. A wavelength compressive antenna element comprising:
a conductor;
a wavelength compressing layer in contact with at least a portion of the conductor; and
a terminal for connecting the antenna element to a circuit, wherein the wavelength compressing layer is configured to compress wavelengths of signals before the signals are incident to the conductor so that the conductor can have at least one dimension that is based on a compressed wavelength of one of the signals and so that the antenna element has a greater bandwidth than another antenna element having the at least one dimension but without the wavelength compressing layer.

2. The antenna element of claim 1 wherein the wavelength compressing layer is of a refraction providing type.

3. The antenna element of claim 2 wherein the wavelength compressing layer comprises at least one of:
a material having a high dielectric; and
a material having a negative dielectric,
and further comprising at least one of:
a material having a real permittivity; and
a material having an imaginary permittivity.

4. The antenna element of claim 2 wherein the wavelength compressing layer comprises a thin film covering the at least a portion of the conductor.

5. The antenna element of claim 2 wherein the wavelength compressing layer comprises a metamaterial.

6. The antenna element of claim 2 wherein the wavelength compressing layer covers at least a portion of the conductor.

7. The antenna element of claim 1 wherein the terminal is connected to an amplifier that is connected to a phase shifter.

8. The antenna element of claim 1 wherein the terminal comprises a slow wave transmission line.

9. An antenna array comprising a plurality of antenna elements of claim 1.

10. The antenna array of claim 9 wherein spacing between at least two of the antenna elements is based on compressed wavelength.

11. A method of receiving signals using a wavelength compressing antenna, the method comprising:
detecting radio frequency (RF) signals propagating through a medium, wherein detecting comprises:
compressing, using a wavelength compressing layer in contact with at least a portion of a conductor, wavelengths of the signals to provide compressed signals to the conductor.

12. The method of claim 11 further comprising at least one of:
modifying compressed signals;
combining modified signals; and
processing combined signals,
as means of providing array antenna output signals to a receiver.

13. The method of claim 11 wherein compressing is conducted with high permittivity material.

14. The method in claim 11 wherein compressing comprises dilating.

15. The method of claim 12 wherein modifying comprises signal phase shifting.

16. The method of claim 12 wherein modifying comprises altering delay of at least one detected signal.

17. The method of claim 12 wherein processing comprises at least one of:
direction finding;
interference cancelling;
array gain providing;
array desensitizing; and
steered transmitting.

18. The method of claim 11 comprising performing the compressing and detecting using each antenna of an array of antennas.

19. The method of claim 18 wherein spacing between antennas in the array is determined according to compressed wavelength.

20. The method of claim 18 further comprising directionally transmitting at least one signal using the conductor.
